(19) United States
(12) Patent Application Publication
(10) Pub. No.: US 2009/0158567 A1
(43) Pub. Date: Jun. 25, 2009

(54) APPARATUS, SYSTEM, AND METHOD FOR FASTENING SCREW AND SHEATH ANCHORS

(76) Inventors: Geoffrey Scott Fulton, Tremonton, UT (US); Issac Nelson, Hyde Park, UT (US)

Correspondence Address: Kunzler & McKenzie, 8 EAST BROADWAY, SUITE 600, SALT LAKE CITY, UT, 84111, US

(21) Appl. No.: 11/963,261

(22) Filed: Dec. 21, 2007

(51) Int. Cl. B23P 19/04

(52) U.S. Cl. 29/240

(57) ABSTRACT

An apparatus, system, and method are disclosed for fastening collapsible anchors. The apparatus comprises a shaft, a screw coupler, and a sleeve which has a hollow interior passage and a mouth that connects to an anchor head. The sleeve moves along the longitudinal axis of the shaft and rotates about that axis independent of the rotation of the shaft. By engaging the screw coupler and mouth to a collapsible anchor, a user can set the anchor by rotating one piece relative to the other. The apparatus may also include a handle or be designed as a drill attachment. The apparatus may also include a stabilizer such as a handle on the shaft. The shaft and sleeve may be designed to fit a variety of different screw couplers and mouths. Additionally, the apparatus may make use of ratchet collars to provide additional ways to set the anchors.

### BACKGROUND OF THE INVENTION

1. Field of the Invention

This invention relates to an apparatus, system, and method for fastening a screw and sheath anchor, and more particularly relates to fastening collapsible screw and sheath anchors.

2. Description of the Related Art

People from a variety of industries use anchors for a wide range of purposes. Anchors are required before almost anything is mounted on a wall or ceiling, particularly where the item to be mounted is large or heavy. Many anchors make use of a screw component and a sheath component—the person drills a hole, places the sheath in the hole, inserts the screw into the sheath and turns the screw. As the screw is turned the sheath expands and makes a strong connection with the wall.

One common type of screw and sheath anchor is the collapsible anchor 100, also known as a mushroom anchor, an example of which is shown in FIG. 1A. This variety of anchor generally has an anchor portion 111 and an associated screw 108. The anchor portion 111 has an anchor head 112 and an anchor sheath 114. The screw 108 has a screw head 110 and a threaded shaft 116.

The screw 108 is set into the anchor portion 111 and, when the screw 108 is it turned, it expands the sides of the anchor sheath 114 such that the sides extend outwards. As a result, the collapsible anchor 100 is set. One popularbrand of collapsible anchor 100 is the Textron FAB-LOK™ fastener. The FAB-LOK™ collapsible anchor 100 comes with the screw 108 pre-set in the anchor sheath 114, and the anchor sheath 114 extends when engaged to form four clamping tines 120a-c shown in FIG. 1B (the fourth tine 120d, opposite the tine 120b, is not visible from the perspective of FIG. 1B). Thus, the user engages the collapsible anchor 100 by inserting the collapsible anchor 100 into the wall, securing the anchor head 112, and turning the screw head 110. As the screw 108 is turned, the four clamping tines 120a-d extend to secure the collapsible anchor 100 as shown in FIG. 1B. The tines 120a-d are on the back side of the wall 124, while an optional washer 118 may be on the front.

Collapsible anchors 100 find a variety of uses. For example, a person may want to mount a box 122 on a wall 124. The person may drill a hole with a diameter approximately equal to the diameter of the closed anchor sheath 114 through the box 122 and wall 124, and then insert the collapsible anchor 100 into the hole. The anchor sheath 114 thus slides into the hole while the anchor head 112 and washer 118, both with a diameter greater than that of the hole, remain on the outside. The user 120 then engages the collapsible anchor 100 such that the clamping tines 120a-d extend as shown in FIG. 1B. As a result, the box 122 is secured to the wall 124 since the anchor head 112 and washer 118 exert pressure on the outside of the wall 124 while the clamping tines 120a-b exert pressure on the inside.

However, setting these collapsible anchors 100 can be difficult in a variety of situations. Most screw and sheath anchors require that the screw 108 turn while the anchor sheath 114 is held stationary. For example, a bottom portion 119 of the FAB-LOK™ sheath is threaded and engages with the screw 108's threaded shaft 116. When the screw head 110 is turned, the screw's threaded shaft 116 and the anchor sheath 114's bottom portion 119 engage and cause the anchor 100 to collapse. If, however, the anchor sheath 114 spins with the screw 108, the tines 120a-d never extend and the collapsible anchor 100 does not fasten.

In order to have the collapsible anchor 100 turn properly, the user needs to turn the screw head 110 while holding the anchor head 112 still, or vice versa. As shown in FIG. 1C, the screw head 110 is generally given a hexagonal shape as shown allowing a standard hex head driver to fit over and turn the screw head 110. Similarly, the anchor head 112 is generally given a shape such as that shown in FIG. 1C (which presents an overhead perspective of a collapsible anchor 100) to facilitate easily engaging the anchor head 112. The patterns shown in FIG. 1C are examples of common shapes, but others may be used and are known to those of skill in the art.

The user may, for example, have a standard hex head driver to turn the screw head 110 and use a pair of pliers, such as slip-joint pliers, to hold the anchor head 112 still while turning the screw head 110. This, however, requires two tools, two hands, and is generally awkward—using the hex driver and pliers takes time and effort and is hard to do, particularly in tight spaces. For example, if the box 122 is small, it can be difficult to fit two tools into the space and easily set the collapsible anchor 100. In addition, since the tools are less precise, it is easy to scratch walls or over-torque the collapsible anchor 100, resulting in damage or weaker settings.

While others have developed solutions to hold an anchor head 112 still while applying torque to the screw head 110, these solutions are often expensive (particularly those that are used as a drill), heavy, and are either difficult or impossible to use in tight spaces such as that shown in FIG. 1B with the box 122.

### SUMMARY OF THE INVENTION

From the foregoing discussion, it should be apparent that a need exists for an apparatus, system, and method for fastening screw and sheath anchors. Beneficially, such an apparatus, system, and method would provide a low-cost, effective mechanism for fastening such screws, particularly in tight spaces.

The present invention has been developed in response to the present state of the art, and in particular, in response to the problems and needs in the art that have not yet been fully solved by currently available tools and methods. Accordingly, the present invention has been developed to provide an apparatus, system, and method for setting collapsible anchors that overcome many or all of the above-discussed shortcomings in the art.

The apparatus for fastening anchors is provided with a plurality of components configured to functionally execute the necessary steps of setting a collapsible anchor. These components in the described embodiments include a shaft having a proximal end, a distal end, and a longitudinal axis. The apparatus further comprises a screw coupler connected to the distal end of shaft such that rotation of the shaft about the longitudinal axis rotates the screw coupler, the screw coupler configured to engage a screw.

The apparatus, in one embodiment, also includes a sleeve comprising a hollow interior passage, the hollow interior passage having an inradius greater than the circumradius of the shaft, and the sleeve further comprising a mouth configured to engage an anchor head. In such an embodiment, the sleeve moves along the longitudinal axis of the shaft in response to a force applied to the sleeve along the longitudinal axis, and the sleeve rotates about the longitudinal axis independent of the rotation of the shaft. The sleeve thus has a slide interface with the shaft along the longitudinal axis.

The apparatus may further comprise a stabilizer that rotates one of the shaft and the sleeve with respect to the other. In one embodiment, the stabilizer may be a sleeve handle at a proximal end of the sleeve, the sleeve handle extending from the longitudinal axis at an angle of between about fifty and about sixty degrees. Alternatively, where the stabilizer is a sleeve handle, the sleeve may further comprise a pivot with the sleeve handle pivotally attached to the pivot.

The apparatus is further configured, in one embodiment, to extend past the screw coupler. In addition, the sleeve may be a cylinder with a length less than the length of the shaft. The hollow interior passage may further comprise a screw coupler void with an inradius greater than an outer circumradius of the screw coupler, the mouth having an inradius greater than the outer circumradius of the screw coupler.

In a further embodiment, the apparatus may further comprise the sleeve having an outer circumradius approximately one-eighth of an inch greater than a circumradius of the mouth.

In a further embodiment, the shaft further comprises the distal end having external threads configured to connect with one of a plurality of screw couplers, each screw coupler comprising a cavity configured to engage the external threads by way of corresponding internal threads. Similarly, the sleeve may further comprise a distal end having a cavity comprising internal threads configured to connect with one of a plurality of mouths, each mouth having an externally threaded exterior configured to connect with the cavity, each mouth further comprising a passage with an inradius greater than a circumradius of the screw coupler.

In an additional embodiment, the sleeve further comprising a pawl extending into the hollow interior passage of the sleeve, wherein the shaft is a gearshaft comprising a plurality of teeth, the pawl configured to engage the teeth and require both the sleeve and the shaft to rotate in one direction and permit rotation of one of the sleeve and the shaft in an opposite direction, and wherein the circumradius of the shaft is the distance from the longitudinal axis to a tooth tip of the gearshaft.

In another embodiment, the apparatus further comprises a first ratchet collar having a shaft component located at a first position and a sleeve component located at a second position, the shaft component ratchetly engaging the sleeve component in response to the mouth engaging the anchor head and the screw coupler engaging the screw. The apparatus may additionally include a second ratchet collar having a second shaft component and a first handle component, the second shaft component ratchetly engaging the first handle component, the second ratchet collar interface configured to permit rotation opposite the rotation permitted by the first ratchet collar.

The apparatus may have a handle connected to the proximal end of the shaft, the proximal end opposite the distal end having the screw coupler. Alternatively, the apparatus may have a motor connected to the proximal end of the shaft, the proximal end opposite the distal end having the screw coupler, the motor rotating the shaft in a direction to set a collapsible anchor.

A system of the present invention is also presented to fasten anchors. In one embodiment, the system includes a collapsible anchor and the apparatus described above. The system may also include a drill or power tool wherein the shaft 212 of the apparatus is configured to connect as an attachment to the drill.

A method of the present invention is also presented for fastening anchors. The method in the disclosed embodiments substantially includes the steps necessary to carry out the functions presented above with respect to the operation of the described apparatus and system. In one embodiment, the method includes inserting an anchor portion and anchor screw into a hole, the anchor portion comprising an anchor head and anchor sheath, the anchor screw comprising a hex head, and a threaded shaft. The method also may include engaging a screw coupler to the hex head, the screw coupler connected to a shaft having a longitudinal axis.

In a further embodiment, the method includes sliding the sleeve along the shaft to engage the sleeve with the anchor head and engaging a mouth of a sleeve to the anchor head, the sleeve comprising a hollow interior passage, the shaft being disposed within the hollow interior passage, the sleeve having a slide interface with the shaft along the longitudinal axis such that the sleeve moves along the longitudinal axis of the shaft in response to a force applied to the sleeve along the longitudinal axis.

The method may additionally include applying a torque to the shaft and an opposite torque to the sleeve such that the sleeve and anchor head are maintained in a stationary position, the shaft and screw rotating about the longitudinal axis in the direction of the torque.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an illustration of one embodiment of a collapsible anchor;

FIG. 1B is an illustration of a collapsible anchor fastening a box to a wall;

FIG. 1C is an illustration of a collapsible anchor from a top-down perspective;

FIG. 2 is an illustration of one embodiment of an apparatus for fastening screw and sheath anchors;

FIG. 3 is a second illustration of one embodiment of an apparatus for fastening screw and sheath anchors;

FIG. 4 is a third illustration of one embodiment of an apparatus for fastening screw and sheath anchors;

FIGS. 5A, 5B, and 5C, are illustrations of one embodiment of an anchor head sleeve from various perspectives;

FIGS. 6A and 6B are an illustration of a sleeve having two different varieties of stabilizers;

FIG. 7A is an illustration of an embodiment of a shaft configured to connect with one of a plurality of screw couplers;

FIG. 7B is an illustration of an embodiment of a sleeve configured to connect with one of a plurality of mouths;

FIG. 8A is an illustration of one embodiment of an apparatus for fastening anchors using a ratcheting system;

FIG. 8B is an illustration of a second embodiment of an apparatus for fastening anchors using a ratcheting system;

FIG. 9 is an illustration of an apparatus for fastening anchors using multiple ratcheting systems;

FIG. 10 is a schematic flow chart diagram illustrating one embodiment of a method for fastening screw and sheath anchors.

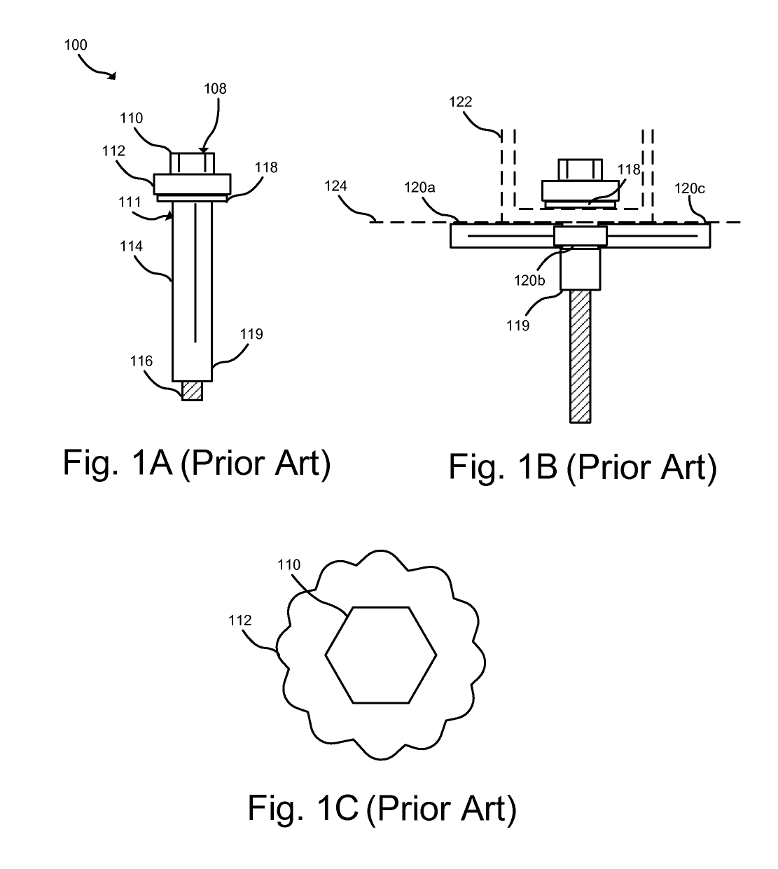

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, ratchet collars and ratcheting mechanisms. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

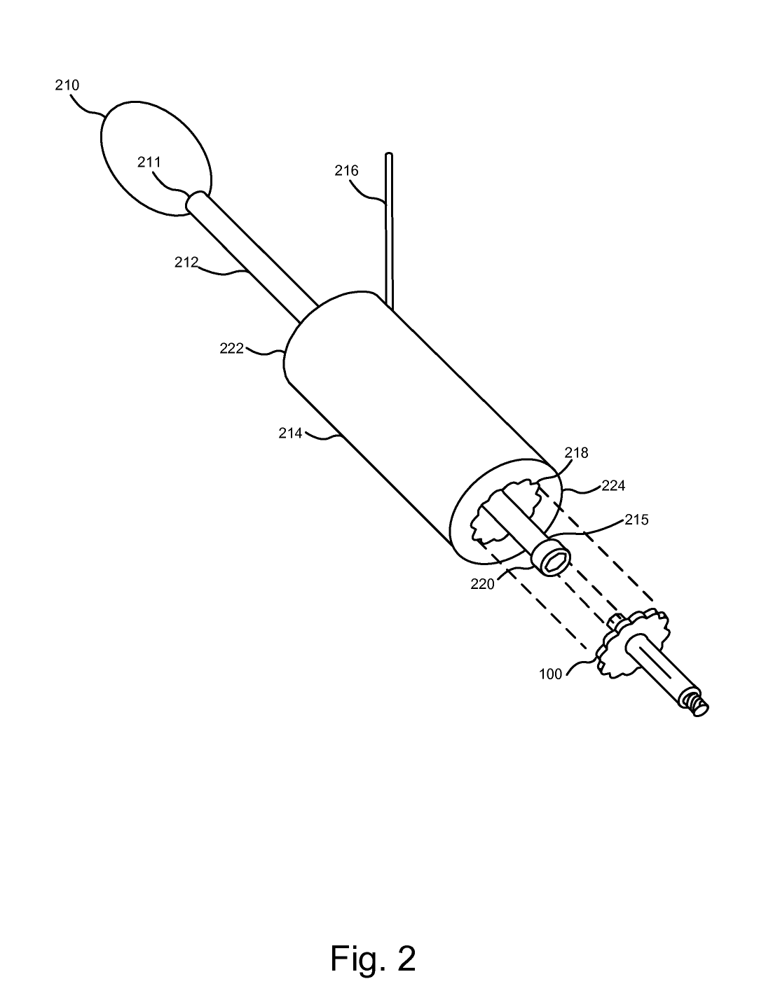

FIG. 2 depicts an apparatus for fastening anchors. The apparatus is particularly suited to fastening collapsible anchors 100 comprising an anchor portion 111 and a screw 108. The apparatus comprises a handle 210, a shaft 212, a sleeve 214, a stabilizer 216, and a screw coupler 220.

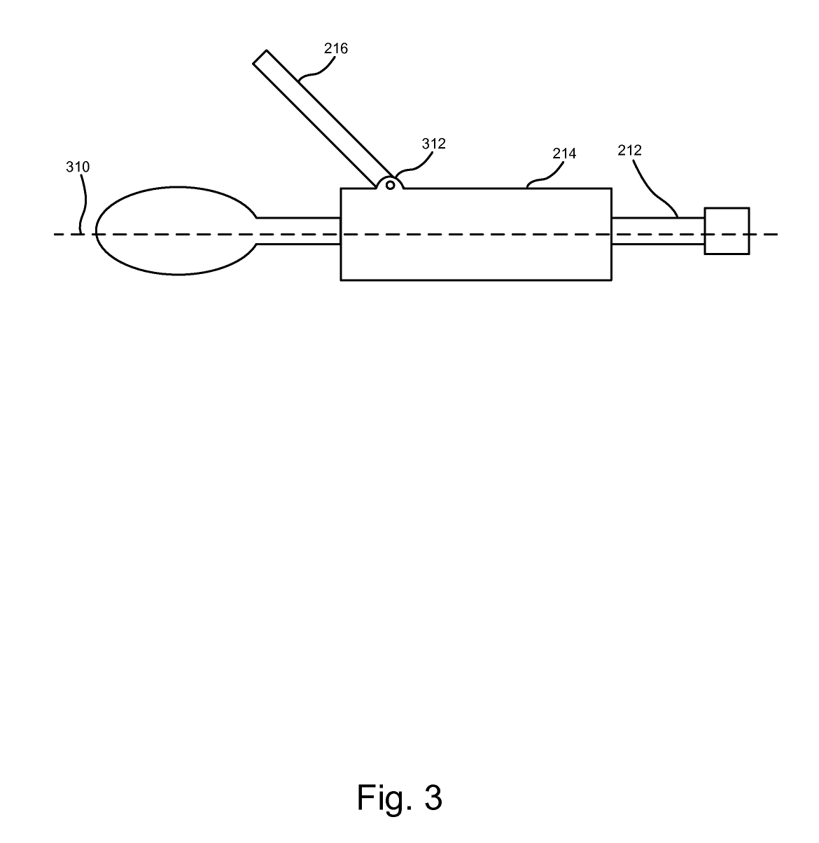

The shaft 212 has a proximal end 211 and a distal end 215. The shaft 212 also has a longitudinal axis shown in FIG. 3. The screw coupler 220 connects to the distal end 215 of the shaft 212. The screw coupler 220 engages the screw head 110 of the screw 108 that is inserted into the anchor portion 111 of the collapsible anchor 100. When the screw coupler 220 engages the screw head 110, rotation of the shaft about its longitudinal axis rotates the screw coupler 220 and also spins the screw 108.

In one embodiment, as depicted, the screw head 110 is a hex head; as such, the screw coupler 220 has a corresponding hexagonal shape that fits over the screw head 110. Those of skill in the art will appreciate that a variety of screw heads 110 are available on the market and the screw coupler 220 is not restricted to any particular shape or configuration. To the contrary, the screw coupler 220 may have any shape designed to fit with a corresponding screw head 110 such that it can engage that particular screw head 110 shape.

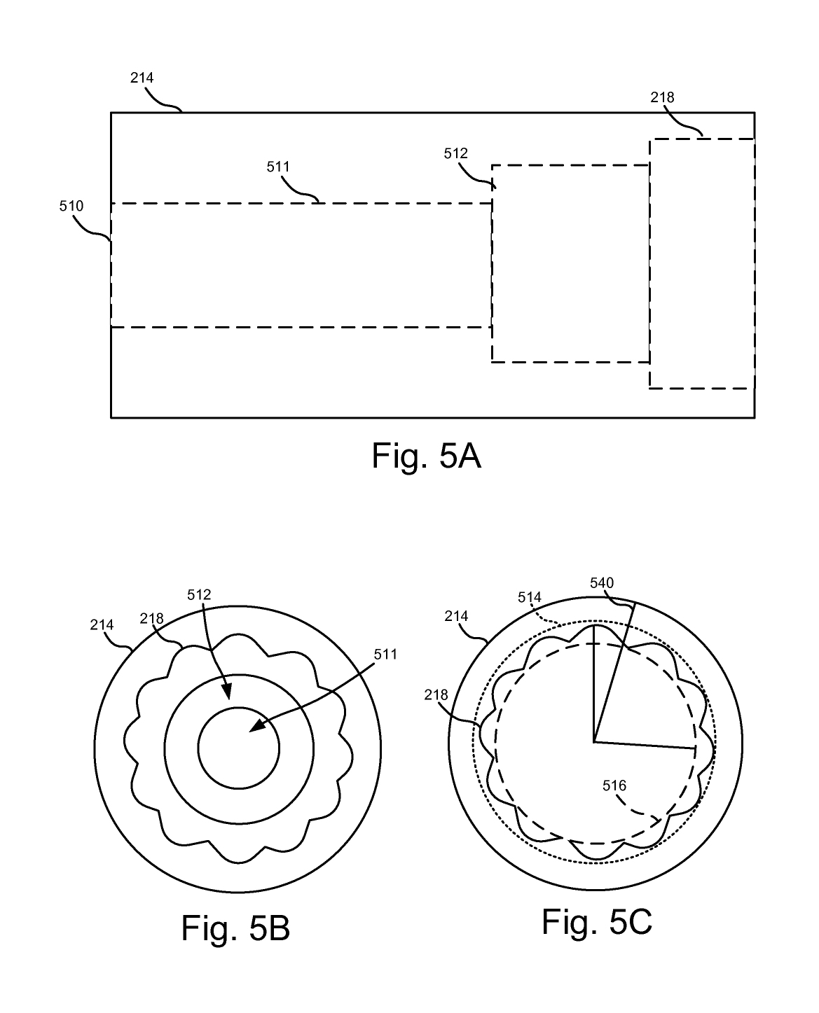

The apparatus further comprises a sleeve 214. The sleeve 214 has a hollow interior passage (discussed in greater detail in FIG. 5) that the shaft 212 passes through freely. In one embodiment, the screw coupler 220 does not fit through at least a portion of the hollow interior passage in order to prevent the sleeve 214 from slipping off the shaft 212. The hollow interior passage has an outer radius that is greater than the radius of the shaft 212 which allows the shaft 212 to fit into the hollow interior passage. As a result, the sleeve 214 fits around the shaft 212, as shown in FIG. 2, and moves along the length of the shaft 212.

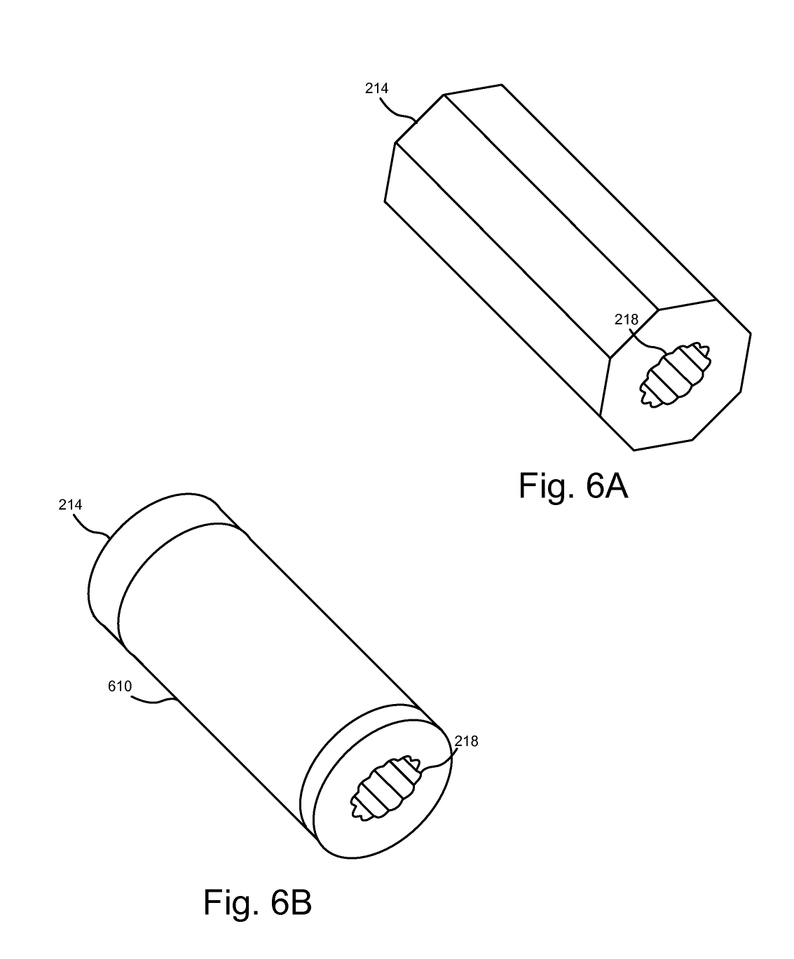

In the depicted embodiment, the sleeve 214 is a cylinder with a length less than a length of the shaft 212 from its proximal end 211 to its distal end 215. However, other shapes are also possible, and in some instances desirable, as shown in connection with FIG. 6. The present invention is not limited to any particular shape of the sleeve 214.

The sleeve 214 further comprises a mouth 218 configured to engage the anchor head 112 of the anchor portion 111 of the collapsible anchor 100. As shown, and discussed in greater detail below, in one embodiment the mouth 218 has an indentation shaped to match the anchor head 112 of the collapsible anchor 100. Generally, the mouth 218 is fitted to match the shape of the anchor head 112 such that, when the mouth 218 engages the anchor head 112, rotating the sleeve 214 rotates the anchor head 112 as well. Similarly, if the sleeve 214 is held stationary, the mouth 218 holds the anchor head 112 stationary as well.

As shown, the sleeve 214 moves along the longitudinal axis of the shaft 212 in response to a force applied to the sleeve 214 along the longitudinal axis. Thus, a user can pull the sleeve 214 back towards the handle 210 in order to expose the screw coupler 220. This may be particularly useful in tight spaces; the user can engage the screw coupler 220 to a screw head 110 without the sleeve 214 obstructing the view. When the screw coupler 220 and the screw head 110 are engaged, the user can then slide the sleeve 214 down the shaft 214 and fit the mouth 218 of the sleeve 214 onto the anchor head 112. Having the sleeve 214 move freely and easily along the longitudinal axis lets the user set one connection at a time (e.g., screw coupler 220 to screw head 110), with a clear view, without having to worry about simultaneously setting the other connection.

In one embodiment, the sleeve 214 and the shaft 212 have a slide interface along the longitudinal axis, allowing the sleeve 214 to slide along the surface of the shaft 212. In other embodiments, the sleeve 214 and the shaft 212 may have a threaded interface whereby the sleeve 214 moves up and down the shaft 212 in response to a torque. The sleeve 214 and shaft 212 may also have a ratchet interface which allows the sleeve 214 to move freely in only one direction along the longitudinal axis of the shaft 212. For example, the sleeve 214 may only move freely towards the screw coupler 215. In such an embodiment, the sleeve 214 may have a release button which allows the sleeve 214 to move back up the length of the shaft 212 when the release button is actuated.

In addition, the sleeve 214 rotates about the longitudinal axis of the shaft 212 independent of the rotation of the shaft 212 itself. As a result, once the screw coupler 220 is engaged with the screw 108, and the mouth 218 is engaged with the anchor head 114, the user can spin the shaft 212 using the handle 210, thus rotating the screw 108. At the same time, the user can hold the shaft 212 still, thus holding the anchor portion 111 of the collapsible anchor 100 still. This prevents both the screw 108 and anchor portion 111 from spinning together in response to the torque applied by the screw coupler 220. Instead, one spins while the other is stationary—as a result, the anchor sheath 112 collapses and extends the clamping tines 120a-d as discussed above.

As a result, the present invention provides a simple, inexpensive, and effective way for setting collapsible anchors 100 with a single tool. In addition, the tool is easy to handle in tight spaces and allows the user to easily make one connection (such as mouth to anchor) and then subsequently make the second connection. As a result, collapsible anchors 100 are far easier to set in a variety of different ways. An additional benefit is the relative lightness of the tool, allowing it to be used overhead with relatively little fatigue in comparison to other solutions.

Also shown in FIG. 2 is an example of a stabilizer. The stabilizer allows the rotation of one of the shaft 212 and the sleeve 214 with respect to the other. For example, in FIG. 2, the sleeve handle 216 located at the proximal end 222 of the sleeve 214 serves as the stabilizer. As shown, the sleeve handle 216 extends from the longitudinal axis of the shaft 212 at an angle of between about fifty and sixty degrees. By locating the sleeve handle 216 at the proximal end 222 of the sleeve 214, the sleeve 214 can more easily fit into tight spaces without the sleeve handle 216 obstructing entrance. Similarly, the angle reduces the likelihood that the sleeve handle 216 will prevent the sleeve 214 from entering the space and engaging the collapsible anchor 100.

While the sleeve handle 216 is located at a proximal end 222 of the sleeve 214, this does not limit the position of the sleeve handle 216 to any specific surface or location at the proximal end 222. For example, the sleeve handle 216 may be located on the top surface of the cylindrical sleeve 214 shown in FIG. 2 or may instead be located at a point along the length of the sleeve 214. This configuration is further shown in FIG. 3.

FIG. 3 shows a second illustration of a tool for setting collapsible anchors 100. FIG. 3 explicitly shows the longitudinal axis 310 of the shaft 212. As discussed above, the sleeve 214 has a slide interface with the shaft 212 along the longitudinal axis 310. If a user applies a force to the sleeve 214 along the longitudinal axis 310, the sleeve 214 slides down the shaft 212 in the direction of the force.

FIG. 3 further shows a stabilizer which is a sleeve handle 216. In the depicted embodiment, the sleeve 214 further comprises a pivot 312 and the sleeve handle 216 is attached to the pivot 312. As a result, the sleeve handle 216 is pivotally attached to the sleeve 214. Methods and mechanisms for making such an attachment are various and well known to those in the art. As such, in the depicted embodiment, the user can adjust the angle that the sleeve handle 216 makes with the longitudinal axis 310. This angle may, for example, range from zero to one-hundred and eighty degrees. In the illustrated embodiment, the sleeve handle 216 makes an angle of about fifty to sixty degrees with the longitudinal axis 310.

FIG. 3 also illustrates that the longitudinal axis 310 of the shaft 212 is the axis about which rotation of both the shaft 212 and the sleeve 214 occurs. In addition, FIG. 3 illustrates that the sleeve 214 has a length which is less than that of the shaft 212. The sleeve 214 is not restricted to any particular length. For example, in one embodiment, the sleeve 214 may simply be a ring sufficiently large to enable the proper functioning of the mouth 218. Preferably, the sleeve 214 is sufficiently long to enable easy use.

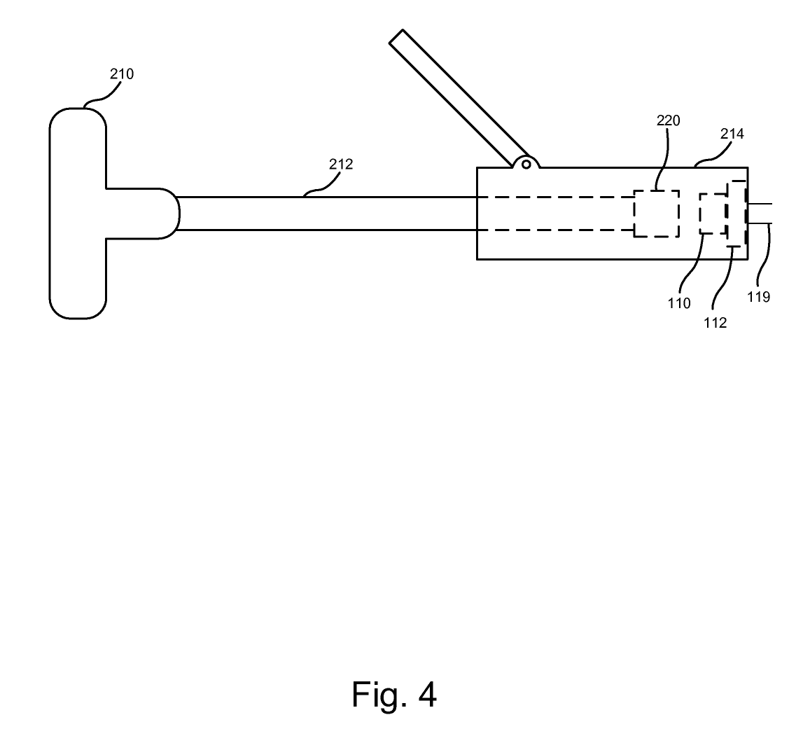

FIG. 4 illustrates another embodiment of the present invention. In the depicted embodiment, the handle 210 has a t-shape as opposed to an oval shape as shown in FIGS. 2 and 3. Those of skill in the art will recognize that the handle 210 is not limited to any particular shape, and a variety of shapes may be used to facilitate ease of use in different situations.

In another embodiment, the handle 210 may not exist at all, and the proximal end 211 of the shaft 212 may be configured to attach to a motor which rotates the shaft 212 in a direction to set the collapsible anchor 100. For example, the proximal end 211 of the shaft 212 may be configured like a drill bit such that the shaft 212 fits into the coupler of a drill.

As illustrated in FIG. 4, the sleeve 214 is configured to extend past the screw coupler 220 as shown. As such, in one embodiment, the shaft 214 may include a screw coupler void into which the screw coupler 220 fits when the sleeve 214 is pushed past the screw coupler 220. The screw coupler 220 may pull back into the screw coupler void sufficiently far such that, when the mouth 218 of the sleeve 214 is engaged with the anchor head 112 (as shown), the screw coupler 220 does not have to be engaged with the screw head 110. Thus, the user can engage the anchor head 112 to the mouth 218 first and then engage the screw head 110 to the screw coupler 220 as a separate step. The opposite order, of course, may also be followed.

FIG. 5A through 5C illustrate a variety of perspectives of the open spaces, voids, and passages of the sleeve 214. FIG. 5A shows a side view of the sleeve 214 and the hollow interior passage 510 comprising the shaft portion 511, the screw coupler void 512, and the mouth 218. The shaft portion 511 begins at the proximal end of the sleeve 214 and extends through the length of the sleeve 214 to the distal end. The shaft portion 511 has a radius greater than the radius of the shaft 212 which will extend through the hollow interior passage 510. Ideally, the radius of the shaft portion 511 is only slightly greater than the radius of the shaft 212 so that the shaft 212 and the sleeve 214 have close fit. This close fit may provide the slide interface discussed above.

While the shaft portion 511 is ideally cylindrical, it may have a variety of different cross-sectional shapes. Similarly, the shaft 212 may have a shape other than cylindrical. However, for each shape, the inradius of the shaft portion 511 must be greater than the circumradius of the shaft 212. Those of skill in the art will recognize that the term circumradius is often used to refer to the radius of a circle which circumscribes the entirety of polygon and touches its vertices. As used in the present specification, the circumradius of a shape refers to a circle whose radius extends from the center point of the shape, away from the longitudinal axis, to the outermost tip of the shape. Thus, for example, the circumradius of a circle or cylinder is the same as its radius. The circumradius of the mouth 218, as shown in FIG. 5C, is shown by the line 514. As described above, tracing the circle using the circumradius 514 gives the dotted circle shown in FIG. 5C.

Similarly, as used in the present specification, the inradius of a shape refers to a circle whose radius extends from the center point of the shape, away from the longitudinal axis, to the innermost tip of the shape. Thus, as shown in FIG. 5C, the inradius of the mouth 218 creates the dotted circle 516.

The hollow interior passage 510 further comprises a screw coupler void 512. As discussed above, the screw coupler void 512 has an inradius greater than the circumradius of the screw coupler 220. As such, the screw coupler 220 can be pulled back into the screw coupler void 512, as shown in FIG. 4, and in one embodiment can be drawn back sufficiently so as to not interfere with the mouth 218 engaging the anchor head 112. In typical embodiments, the screw coupler void 512 is at least sufficiently deep to allow the screw coupler 220 to be drawn in far enough to allow the mouth 218 to engage the anchor head 112.

FIG. 5B is a top-down perspective of one embodiment of the sleeve 214 in accordance with the present invention. FIG. 5B presents the perspective of the sleeve 214 when looking directly into it from the distal end. As such, the outer wall of the sleeve 214 is the outermost circle. Moving inwards, the mouth 218 is shown. The mouth 218 is generally a shaped impression into the sleeve 214 and typically has indentations or a shape which enables the mouth 218 to securely grip an anchor head 112. The impression may only be four to five millimeters deep, or may be deeper. The mouth 218 should have sufficient depth to allow it to engage the anchor head 112 firmly in light of the torque that will be applied when the collapsible anchor 100 is set.

Also shown is the screw coupler void 512. As mentioned above, this space has an inradius sufficiently large to allow the screw coupler 220 to fit within it. In addition, it has sufficient depth to at least accept the screw coupler 220 coupled with the screw head 110 and simultaneously allow the mouth 218 to engage the anchor head 112. Also shown is the shaft portion 511 described above. As such, FIG. 5B shows the hollow interior passage 510 presenting an opening from the proximal end to the distal end of the sleeve 214. While the hollow interior passage 510 may comprise various stages of varying inradius, in most embodiments each inradius is at least greater than the circumradius of the shaft 212.

FIG. 5C also shows the difference between the circumradius 514 of the mouth 218 and the outer radius 540 of the sleeve 214. In one embodiment, the outer radius 540 is approximately one-eighth of an inch greater than the circumradius 514 of the mouth 218. Such an embodiment may be particularly useful in very tight spaces where the space surrounding the anchor head 112, which generally has the greatest extent on a collapsible anchor 100, is not much greater than the extent of the anchor head 112.

FIGS. 6A and 6B illustrate two alternative embodiments of a sleeve 214 with different stabilizers. FIG. 6A shows a sleeve 214 with a stabilizer comprising an octagonal shape. In such an embodiment, the sleeve 214 may provide a better grip to the user than a cylindrical shape, allowing the user to set a collapsible anchor without the need for a sleeve handle. Consequently, an operator may stabilize the sleeve 214 by holding it with one hand, and turn the shaft 212 with the other hand. In addition, the octagonal shape may allow the user to couple a wrench or other tool to the outside of the sleeve 214 and use the wrench to facilitate setting the screw.

FIG. 6B shows a sleeve 214 with a stabilizer comprising a grip 610. The grip 610 may be a tacky rubber or other similar material to allow the user to more easily grip and either turn or maintain the sleeve 214 when setting a collapsible anchor 100. In addition, the grip 610 may provide a variety of indentations matching the position of the fingers and/or thumb of the user to facilitate a better grip of the sleeve 214.

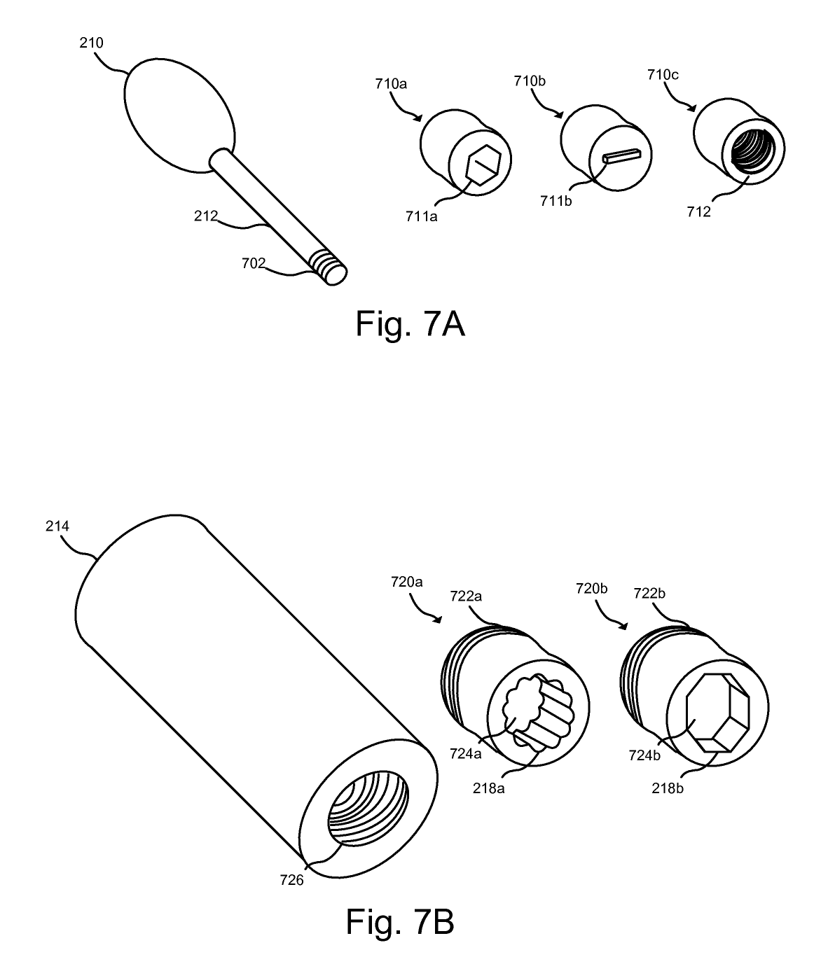

FIGS. 7A and 7B show an additional embodiment of a shaft 212 and sleeve 214 respectively. FIG. 7A shows a shaft 212 which further comprises the distal end having external threads 702 which are configured to connect with one of a plurality of screw couplers 710a-c. Each screw coupler 710a-c has a coupler cavity 712 which is configured to engage the external threads 702 by way of the corresponding internal threads shown in the coupler cavity 712.

The screw couplers 710a-b are shown with two different screw interfaces 711a-b. The screw interfaces 711a-b could be any variety of shape and size known to those of skill in the art which are used to connect with a screw. The screw coupler 710c is oriented opposite the screw couplers 710a-b and shows the coupler cavity 712 representative of the coupler cavity 712 of the screw couplers 710a-c.

The shaft 212 and screw coupler 710a-c pairings shown in FIG. 7A allow the apparatus to work with a variety of collapsible anchors 100 which may have a variety of differently shaped screw heads 110. Embodiments with a set of removable screw couplers 710a-c provide greater versatility. In one embodiment, the external threading 702 on the shaft 212 engages the internal threading in the coupler cavity 712 such that they engage and tighten when torque is being applied to the shaft 212 and an attached screw coupler 710a-c, as would be the case when the apparatus was in use to set a collapsible anchor 100. In such a configuration, utilizing the apparatus would not result in the screw coupler 710a-c disengaging from the shaft 212.

Those of skill in the art will appreciate that the plurality of screw couplers 710a-c and the shaft 212 may comprise a variety of means for attachment other than that shown in FIG. 7A. For example, the shaft 212 may have a set of grooves and the coupler cavity 712 a set of corresponding protrusions which fit into the grooves, along with a locking mechanism to keep the screw coupler 710a-c from simply falling off the end. In such an embodiment, the connection between the shaft 212 and an attached screw coupler 710a-c would not tighten when in use, as may be the case with the threaded embodiment.

FIG. 7B depicts an embodiment of a sleeve 214 configured to attach to a plurality of mouths 720a-b. In the depicted embodiment, the sleeve 214 comprises a distal end having a cavity 726 with internal threads configured to connect with one of the plurality of mouths 720a-b shown. Each mouth 720a-b has external threads 722a-b on its exterior which are configured to connect to the internal threads of the sleeve cavity 726. In addition, each mouth 720a-b further comprises a passage 724a-b with an inradius greater than the circumradius of the screw coupler 710a-c.

As above, the configuration in FIG. 7B expands the versatility of the apparatus by allowing it work with a variety of different anchor head 112 shapes. In one embodiment, the threading of the cavity 726 engages the external threads 722a-b of the mouth 720a-b such that the action applied to the sleeve 214 in the course of setting an anchor further engages or tightens the connection instead of detaching the two. In addition, as discussed above, a variety of different methods and approaches may be used to couple the sleeve 214 to a mouth 720a-b.

In such an embodiment, a user may choose an appropriate mouth 720a-b and attach it to the sleeve 214. The user can then insert the shaft 212 through the hollow interior passage of the sleeve 214 and then attach a screw coupler 710a-c onto the shaft 212. With the appropriate attachments in place, the apparatus essentially behaves as described above. However, if the user at any point changes the collapsible anchors 100 with which he is working, he can simply replace one of, or both of, the screw coupler 710a-c and mouth 720a-b to correspond to the particular anchor being used.

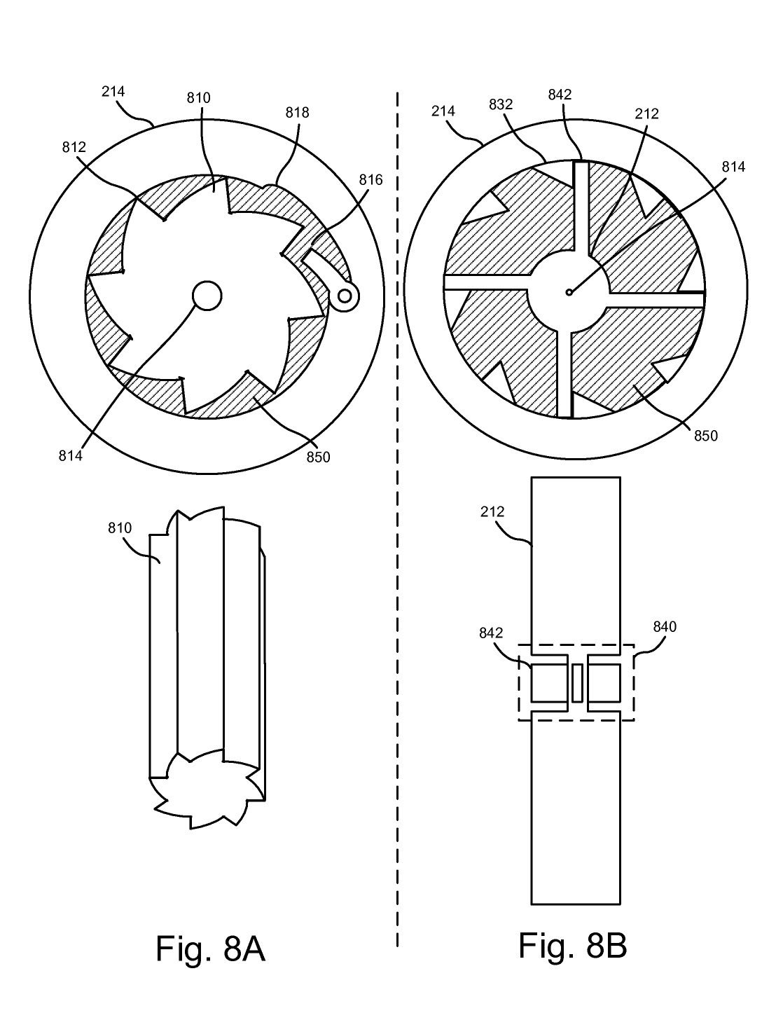

FIGS. 8A and 8B illustrate additional embodiments of a shaft 212 and sleeve 214 configuration. FIG. 8A shows an embodiment of the present invention using a gear shaft 810 and sleeve-mounted pawl 816 to create a ratchet interface. While the sleeve 214 and the gear shaft 810 still maintain a slide interface along the longitudinal axis 814, the gear shaft 810 can only spin in one direction around the longitudinal axis 810.

In the depicted embodiment, the pawl 816 extends into the hollow interior passage of the sleeve 214 and engages the teeth 812 of the gearshaft 810. Those of skill in the art will appreciate that the present invention is not limited to any particular number of teeth 812 on the gearshaft 810. In one embodiment, the pawl is mounted in a housing 818 of the shaft 214 with a pivot, as shown. In such an embodiment, the pawl is also equipped with a spring (not shown) such that the default position of the pawl 816 is one engaging the teeth 812.

If the gearshaft 810 is spun in the clockwise direction, the pawl 816 prevents the gearshaft 810 from spinning by engaging one of the teeth 812. If the gearshaft is spun counterclockwise, however, the smooth, curved end of the teeth 812 pushes the pawl 816 into the housing 818. While the spring pushes the pawl 816 back into an engagement position when the particular tooth 812 is past, the next tooth 812 simply repeats the process so long as the gearshaft 810 is being spun counterclockwise. Those of skill in the art will appreciate that the system shown in FIG. 8A may be simply reconfigured to allow spinning in a clockwise direction and prevent it in a counterclockwise direction.

In use, the user may hold a handle attached to the gearshaft 810, which in turn has a screw coupler on its end, as described above. Similarly, the sleeve 214 would also comprise a mouth as described above. With the screw coupler attached to the screw head and the mouth attached to the anchor head, the user spins the gearshaft 810 using the handle and holds the shaft 214 still to set the collapsible anchor. The ratcheting described in connection with FIG. 8A, however, would require that the user spin the gearshaft 810 in relation to the sleeve 214 in the correct direction to set the collapsible anchor.

Thus the pawl 816 engages the teeth 812 such that both the sleeve 214 and the gearshaft 810 rotate in one direction (in the depicted example, the clockwise direction) and permits rotation of one of the sleeve 214 and the gearshaft 810 in the opposite direction. In the embodiment depicted in FIG. 8A, and as described above, the circumradius of the gearshaft 810 is the distance from the longitudinal axis 814 to a tooth 812 tip of the gearshaft 810.

FIG. 8B shows an additional embodiment of a ratcheting mechanism that may be used in connection with the present invention. Rather than including an entire gearshaft 810, the shaft 212 may instead comprise a second ratchet collar interface 840 that corresponds to a first ratchet collar interface on the sleeve 214. Those of skill in the art will appreciate that the depicted ratchet collar interface described in connection with FIG. 8B is simply one example of a number of possible ratchet collar interfaces, and that the present invention is not limited to any particular configuration.

In the depicted embodiment, the shaft 212 comprises a number of paddles 842 extending away from the longitudinal axis 814. The shaft 214 comprises a plurality of collapsible teeth 832 along at least a portion of the hollow interior. The collapsible teeth 832, in one embodiment, each have a corresponding housing (not shown) in the sleeve 214. In addition, the collapsible teeth 832 are spring-mounted in the housing such that, in the absence of a force pushing them radialy outwards, the collapsible teeth 832 extend into the hollow interior passage 850 of the sleeve 214.

In such an embodiment, if the shaft 212 is spun clockwise, the shaft 212 spins freely since the paddles 842 press the collapsible teeth 832 into their respective housings as they rotate over them. However, if the shaft 212 is spun counterclockwise, the paddles 842 simply collide with the flat end of the collapsible teeth 832 without pushing them into the housing; as such, the shaft 212 cannot spin freely in the counterclockwise direction. Rotation in the counterclockwise direction results in both the shaft 212 and the sleeve 214 spinning together.

In one embodiment, the collapsible teeth 832 also collapse into their housings in response to a force applied along the longitudinal axis 814. As a result, the shaft 212 can still freely slide up and down the length of the sleeve 214 and is not restricted to a position where the first ratchet interface of the sleeve and the second ratchet interface 840 of the shaft 212 are aligned.

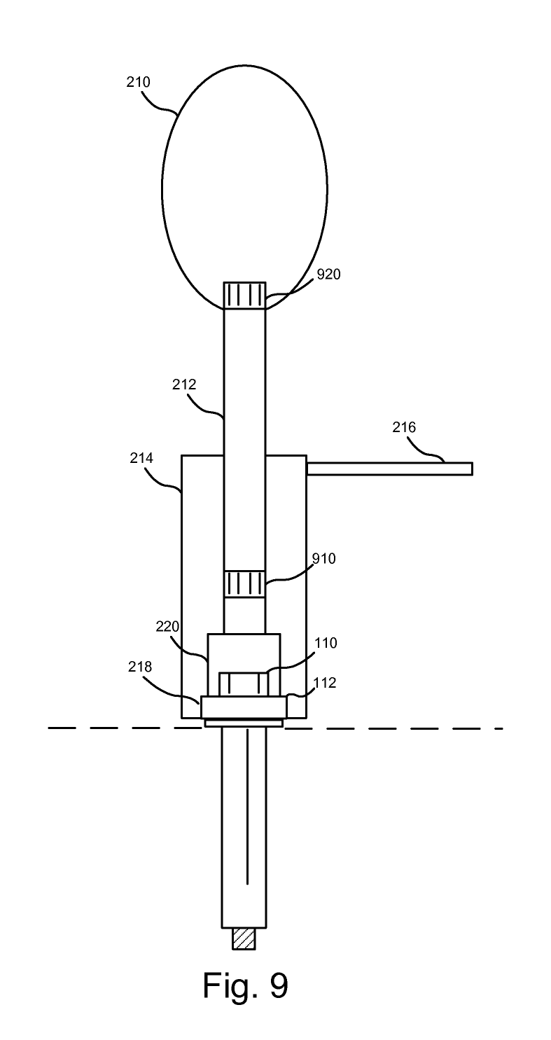

FIG. 9 illustrates one embodiment of the apparatus incorporating ratchet collars. As shown, the screw coupler 220 is engaged with the screw head 110 and the mouth 218 is engaged with the anchor head 112. A first ratchet collar 910 comprises a shaft component of the first ratchet collar 910 and a sleeve component of the first ratchet collar. Examples of a ratchet collar 910 and the associated interfaces were discussed in connection with FIG. 8A and FIG. 8B. The shaft component is located at a first position, and the sleeve component at a second position. These positions are aligned when the mouth 218 is engaged with the anchor head 112 and the screw coupler 220 is engaged with the screw head 110. As a result, the shaft component ratchetly engages the sleeve component in response to the mouth 218 engaging the anchor head 112 and the screw coupler 220 engaging the screw 108.

A ratchet engagement allows unidirection rotation of a single component of the engagement with respect to the other, and does not allow rotation of a single component with respect to the other in the opposite direction. Ideally, the ratchet engagement of the first ratchet collar 910 is such that the allowed rotation is in a direction that sets the collapsible anchor 100.

Also shown is a second ratchet collar 920 having a second shaft component and a first handle component. The second shaft component ratchetly engages the first handle component as discussed above. The second ratchet collar 920 is ideally configured to permit rotation opposite the rotation permitted by the first ratchet collar 910. Such an embodiment allows the operation of the apparatus as discussed extensively above. However, in addition, it provides additional options for setting collapsible anchors.

For example, the user may instead choose to set the collapsible anchor by rotating the shaft 214 and holding the shaft 212 still using the handle 210. The user can rotate the sleeve 214 by means of a partial turn using the sleeve handle 216. The user can then rotate the sleeve handle 216 back to its original position without having to release the handle 210 and without rotating the anchor head 112 with respect to the screw 108. The ratchet collars 910 and 920, in cooperation, provide this additional functionality. Such an embodiment might be particularly useful in very tight spaces where it is difficult to turn the shaft 212 or the sleeve 214 in full rotations. The embodiment depicted in FIG. 9 allows the user to set the collapsible anchor using only many partial turns instead of a few full turns.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

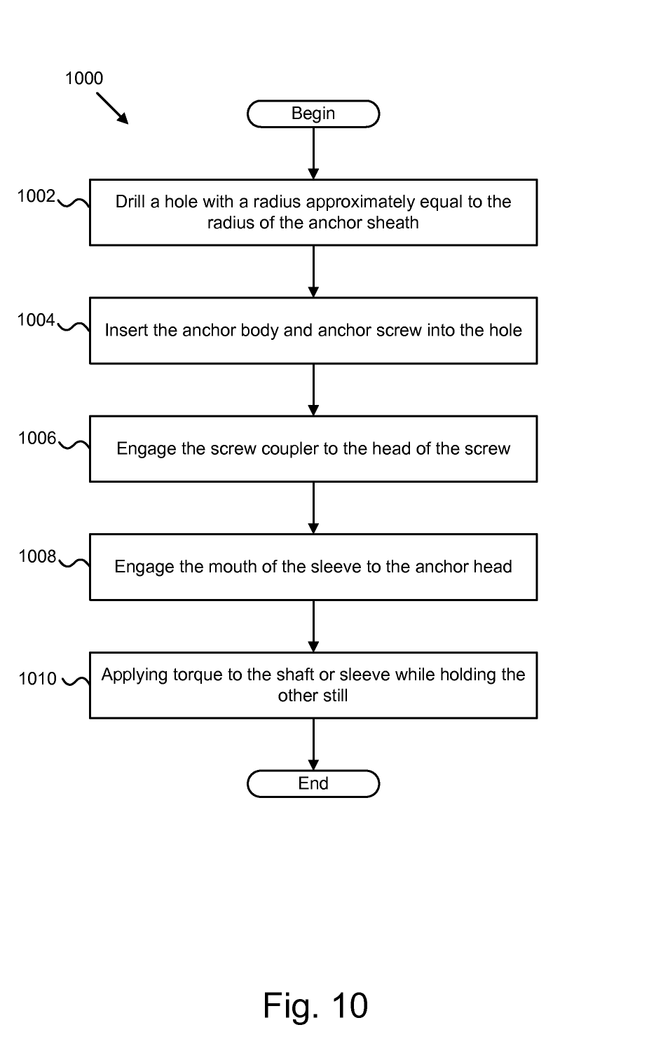

FIG. 10 illustrates a method for setting collapsible anchors 100 in accordance with the present invention. The method begins with a user drilling 1002 a hole with a radius approximately equal to, but slightly larger than, the radius of the anchor sheath 114. The user then inserts 1004 the anchor portion 111 and screw 108 into the hole. As discussed above, the anchor portion 111 comprises an anchor head 112 and an anchor sheath 114. The screw 108 comprises a screw head 110 which may be a hex head, and a threaded shaft 116.

The user then engages 1006 the screw coupler 220, which is connected to the shaft 212, to the screw head 110. With the screw head 110 engaged, the user may then slide the sleeve 214 along the longitudinal axis 310 of the shaft 212 to engage 1008 the mouth 218 of the sleeve 214 to the anchor head 112. As discussed above, the shaft 212 is disposed within the hollow interior passage 510 of the sleeve 214, and has a slide interface with the sleeve 214 along its longitudinal axis 310. As such, the sleeve 214 moves along the longitudinal axis 310 in response to a force applied to the sleeve along the longitudinal axis 310.

With the relevant pieces of the collapsible anchor 100 engaged, the user then applies 1010 torque to the shaft 212 and an opposite torque to the sleeve 214 such that the sleeve 214 and anchor head 112 are maintained in a stationary position while the shaft 212 and screw 108 rotate about the longitudinal axis 310 in the direction of the torque. Those of skill in the art will recognize that any time a piece is held stationary, an opposite torque must be applied to counter the torque applied to spin another piece. The user may also spin both the shaft 212 and the sleeve 214 in opposite directions to set the collapsible anchor 100 more quickly.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for fastening anchors comprising:
a shaft having a proximal end, a distal end, and a longitudinal axis;
a screw coupler connected to the distal end of the shaft such that rotation of the shaft about the longitudinal axis rotates the screw coupler, the screw coupler configured to engage a screw;
a sleeve comprising a hollow interior passage, the hollow interior passage having an inradius greater than a circumradius of the shaft, the sleeve further comprising a mouth configured to engage an anchor head; and
wherein the sleeve moves along the longitudinal axis of the shaft in response to a force applied to the sleeve along the longitudinal axis, and wherein the sleeve rotates about the longitudinal axis independent of the rotation of the shaft.

2. The apparatus of claim 1, further comprising a stabilizer that rotates one of the shaft and the sleeve with respect to the other.

3. The apparatus of claim 1, the sleeve having a slide interface with the shaft along the longitudinal axis.

4. The apparatus of claim 2, wherein the stabilizer is a sleeve handle positioned at a proximal end of the sleeve, the sleeve handle extending from the longitudinal axis at an angle of between about fifty and about sixty degrees.

5. The apparatus of claim 2, wherein the stabilizer is a sleeve handle, and wherein the sleeve further comprises a pivot, the sleeve handle attached to the pivot.

6. The apparatus of claim 1, wherein the sleeve is configured to extend past the screw coupler.

7. The apparatus of claim 1, wherein the sleeve is a cylinder with a length less than a length of the shaft, the hollow interior passage further comprising a screw coupler void with an inradius greater than an outer circumradius of the screw coupler, the mouth having an inradius greater than the outer circumradius of the screw coupler.

8. The apparatus of claim 1, wherein the sleeve further comprises an outer circumradius approximately one-eighth of an inch greater than a circumradius of the mouth.

9. The apparatus of claim 1, wherein the distal end of the shaft comprises external threads configured to connect with one of a plurality of screw couplers, each screw coupler comprising a cavity configured to engage the external threads by way of corresponding internal threads.

10. The apparatus of claim 1, the sleeve further comprising a distal end having a cavity comprising internal threads configured to connect with one of a plurality of mouths, each mouth having an externally threaded exterior configured to connect with the cavity, each mouth further comprising a passage with an inradius greater than a circumradius of the screw coupler.

11. The apparatus of claim 1, the sleeve further comprising a pawl extending into the hollow interior passage of the sleeve, wherein the shaft is a gearshaft comprising a plurality of teeth, the pawl configured to engage the teeth and require both the sleeve and the shaft to rotate in one direction and permit rotation of one of the sleeve and the shaft in an opposite direction, and wherein the circumradius of the shaft is the distance from the longitudinal axis to a tooth tip of the gearshaft.

12. The apparatus of claim 1, further comprising a first ratchet collar having a shaft component located at a first position, and a sleeve component located at a second position, the shaft component ratchetly engaging the sleeve component in response to the mouth engaging the anchor head and the screw coupler engaging the screw.

13. The apparatus of claim 12, further comprising a second ratchet collar having a second shaft component and a first handle component, the second shaft component ratchetly engaging the first handle component, the second ratchet collar interface configured to permit rotation opposite the rotation permitted by the first ratchet collar.

14. The apparatus of claim 1, further comprising a handle connected to the proximal end of the shaft, the proximal end opposite the distal end having the screw coupler.

15. The apparatus of claim 1, further comprising a motor connected to the proximal end of the shaft, the proximal end opposite the distal end having the screw coupler, the motor rotating the shaft in a direction to set a collapsible anchor.

16. A system for fastening anchors, the system comprising:
a collapsible anchor; and
an apparatus for fastening the collapsible anchor, the apparatus comprising:
a shaft having a longitudinal axis;
a screw coupler connected to the shaft such that rotation of the shaft about the longitudinal axis rotates the screw coupler, the screw coupler configured to engage a screw;
a sleeve comprising a hollow interior passage, the hollow interior passage having an inradius greater than the circumradius of the shaft, the sleeve further comprising a mouth configured to engage an anchor head; and
wherein the sleeve moves along the longitudinal axis of the shaft in response to a force applied to the sleeve along the longitudinal axis, and wherein the shaft rotates about the longitudinal axis independent of the rotation of the shaft about the longitudinal axis.

17. The system of claim 16, the apparatus further comprising a sleeve handle at a proximal end of the sleeve, the sleeve handle extending from the longitudinal axis at an angle of between about fifty and about sixty degrees.

18. The system of claim 16, wherein the sleeve is a cylinder with a length less than the length of the shaft, the hollow interior passage further comprising a screw coupler void with an inradius greater than an outer circumradius of the screw coupler, and the mouth further comprising a passage with an inradius greater than the outer circumradius of the screw coupler.

19. A method for securing an anchor, the method comprising:
inserting an anchor portion and anchor screw into a hole, the anchor portion comprising an anchor head and anchor sheath, the anchor screw comprising a hex head, and a threaded shaft;
engaging a screw coupler to the hex head, the screw coupler connected to a shaft having a longitudinal axis;
engaging a mouth of a sleeve to the anchor head, the sleeve comprising a hollow interior passage, the shaft being disposed within the hollow interior passage, the sleeve having a slide interface with the shaft along the longitudinal axis such that the sleeve moves along the longitudinal axis of the shaft in response to a force applied to the sleeve along the longitudinal axis;
applying a torque to the shaft and an opposite torque to the sleeve such that the sleeve and anchor head are maintained in a stationary position, the shaft and screw rotating about the longitudinal axis in the direction of the torque.

20. The method of claim 19, further comprising sliding the sleeve along the shaft to engage the sleeve with the anchor head.
